(19) United States
(12) Patent Application Publication
(10) Pub. No.: US 2026/0192310 A1
(43) Pub. Date: Jul. 9, 2026

(54) SHOWERHEAD FOR SUBSTRATE PROCESSING TOOL

(71) Applicant: Lam Research Corporation, Fremont, CA (US)

(72) Inventors: Bin LUO, Beaverton, OR (US); Sean M DONNELLY, Portland, OR (US); Eric MADSEN, Sherwood, OR (US); Jeffrey WOMACK, Lake Oswego, OR (US); Keith Joseph MARTIN, Tualatin, OR (US)

(21) Appl. No.: 19/133,913

(22) PCT Filed: Nov. 8, 2023
(86) PCT No.: PCT/US2023/079120

§ 371 Date: May 29, 2025

Related U.S. Application Data
(60) Provisional application No. 63/387,873, filed on Dec. 16, 2022.

(51) Int. Cl. B05B 1/18

(52) U.S. Cl. CPC B05B 1/1821

(57) ABSTRACT

One example provides a showerhead for a substrate processing tool. The showerhead comprising a faceplate comprising a plurality of outlet holes, a backplate coupled to the faceplate, a plenum between the faceplate and backplate, and a plurality of posts connecting the faceplate and the backplate, an outermost set of posts of the plurality of posts being positioned between 45% and 65% of a distance from a center of the plenum to a perimeter of the plenum and no posts being positioned between 65% and 100% of the distance from the center of the plenum to the perimeter of the plenum.

### BACKGROUND

Semiconductor processing tools can include components designed to distribute processing gases in a relatively even manner across a substrate. Such components are commonly referred to in the industry as “showerheads.” Showerheads typically include a faceplate that fronts a plenum. The faceplate includes a plurality of outlet holes that allow processes gases in the plenum to flow through the faceplate and over a surface of the substrate. The through-holes are arranged such that the gas distribution across the wafer results in substantially uniform processing of the substrate.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

One example provides a showerhead for a substrate processing tool. The showerhead comprises a faceplate comprising a plurality of outlet holes, a backplate coupled to the faceplate, a plenum between the faceplate and backplate, and a plurality of posts connecting the faceplate and the backplate. An outermost set of posts of the plurality of posts is positioned between 45% and 65% of a distance from a center of the plenum to a perimeter of the plenum and no posts are positioned between 65% and 100% of the distance from the center of the plenum to the perimeter of the plenum.

In some such examples, alternatively or additionally the outermost set of posts of the plurality of posts is positioned between 50 and 65% of the distance from a center of the plenum to a perimeter of the plenum.

In some such examples, alternatively or additionally the outermost set of posts of the plurality of posts is positioned between 52 and 58% of the distance from a center of the plenum to a perimeter of the plenum, and no posts are positioned between 58% and 100% of the distance from the center of the plenum to the perimeter of the plenum.

In some such examples, alternatively or additionally the plurality of posts are arranged such that any radial line extending from the center of the plenum to a perimeter of the plenum intersects a maximum of one post.

In some such examples, alternatively or additionally the plurality of posts are arranged such that any radial line extending from the center of the plenum to a perimeter of the plenum intersects a maximum of one post.

In some such examples, alternatively or additionally the plurality of posts comprises 20 or more posts.

In some such examples, alternatively or additionally the faceplate has a thickness greater than 0.35 inch and equal to or less than 1 inch.

In some such examples, alternatively or additionally the faceplate has a thickness within a range of 0.45 inch to 0.65 inch.

In some such examples, alternatively or additionally the backplate comprises a post access hole for each post, each post access hole comprising a radiused edge at an opening of the post access hole to an outer surface of the backplate.

In some such examples, alternatively or additionally each post is integral with the faceplate and welded to the backplate, and wherein each post comprises a radius where the post meets an inner surface plane of the faceplate.

In some such examples, alternatively or additionally the outermost set of posts is arranged in a circular pattern with at least three posts per each quadrant of the circular pattern, a first post being spaced from a second post of the three posts by a first angular distance along the circular pattern, and the second post being spaced from a third post by a second angular distance along the circular pattern, the first distance being shorter than the second distance.

Another example provides a showerhead for a substrate processing tool. The showerhead comprises a faceplate comprising a plurality of outlet holes, a backplate coupled to the faceplate, a plenum between the faceplate and backplate, a plurality of posts connecting the faceplate and the backplate, and a plurality of post access holes formed in the backplate, each post access hole comprising a radiused edge at an opening of the post access hole to an outer surface of the backplate.

In some such examples, alternatively or additionally a radius of curvature of the radiused edge is within a range of 0.05 inch to 0.25 inch.

In some such examples, alternatively or additionally an outermost set of posts of the plurality of posts is positioned between 52 and 58% of the distance from a center of the plenum to a perimeter of the plenum, and wherein no posts are positioned between 58% and 100% of the distance from the center of the plenum to the perimeter of the plenum.

In some such examples, alternatively or additionally the posts of the plurality of posts are arranged such that any radial line extending from the center of the plenum to a perimeter of the plenum intersects a maximum of one post.

In some such examples, alternatively or additionally the plurality of posts comprises 20 or more posts.

In some such examples, alternatively or additionally the faceplate has a thickness greater than 0.45 inch and equal to or less than 0.55 inch.

Another example provides a showerhead for a substrate processing tool. The showerhead comprises a faceplate comprising a plurality of outlet holes, a backplate coupled to the faceplate, a plenum between the faceplate and backplate, and a plurality of posts connecting the faceplate and the backplate, an outermost set of posts of the plurality of posts being arranged in a circular pattern with at least three posts per each quadrant of the circle pattern, a first post being spaced from a second post of the three posts by a first angular distance along the circular pattern, and the second post being spaced from a third post by a second angular distance along the circular pattern, the first distance being shorter than the second distance.

In some such examples, alternatively or additionally the outermost set of posts of the plurality of posts is positioned between 52 and 58% of the distance from a center of the plenum to a perimeter of the plenum, and wherein and no posts are positioned between 58% and 100% of the distance from the center of the plenum to the perimeter of the plenum.

In some such examples, alternatively or additionally the backplate comprises a post access hole for each post, each post access hole comprising a radiused edge at an opening of the post access hole to an outer surface of the backplate.

### BRIEF DESCRIPTION OF THE DRAWINGS

FIG. 1 shows a schematic depiction of an example processing tool comprising a showerhead.

FIG. 2 shows a perspective view of an example showerhead.

FIG. 3 shows a sectional view of the showerhead of FIG. 2.

FIG. 4 shows a top view of the showerhead of FIG. 2.

FIG. 5 shows a schematic depiction of an example placement of posts on a showerhead faceplate.

FIG. 6 shows a sectional view of a post access hole of a backplate of the showerhead of FIG. 2.

FIG. 7 shows a perspective view of a radiused joint where a post meets an inner surface plane of a faceplate of an example showerhead.

FIG. 8 shows a sectional view of a gas flow baffle and support post of an example showerhead.

### DETAILED DESCRIPTION

The term “atomic layer deposition” (ALD) generally represents a process in which a film is formed on a substrate in one or more individual layers by sequentially adsorbing a precursor to a substrate and then chemically transforming the adsorbed precursor to form a film layer.

The term “backplate” generally represents a component part of a showerhead. The backplate, together with a faceplate, defines a plenum of the showerhead. The backplate faces away from a substrate holder of a processing tool.

The term “chemical vapor deposition” (CVD) generally represents a process in which a film is formed on a substrate by exposing the substrate to a flow of reactive gas phase precursors.

The term “etch” generally represents removal of a material from a substrate. A wet etch uses a liquid phase solution to remove material from a substrate. A dry etch uses gas phase chemicals to remove material from a substrate.

The term “faceplate” generally represents a part of a showerhead that faces toward a substrate holder of a processing tool. A faceplate comprises outlet holes to emit processing chemicals from a plenum located behind the faceplate toward a substrate.

The term “outlet hole” generally represents an opening in a showerhead through which processing chemicals are emitted from a plenum toward a substrate during substrate processing.

The term “plenum” generally represents a volume of space between a faceplate and a backplate. Processing gases flow into the plenum through a processing gas inlet, and flow out of the plenum toward a substrate through a plurality of outlet holes. The outlet holes extend through a faceplate to fluidly connect the plenum with an environment external to the plenum.

The term “post” generally represents a structural support that extends between a faceplate and a backplate of a showerhead across a plenum of the showerhead. A post can be formed integrally with a faceplate and welded to the backplate.

The term “processing chamber” generally represents an enclosure in which chemical and/or physical processes are performed on substrates. Processing tool components such as a showerhead and a pedestal are located within the processing chamber.

The term “quadrant” generally represents a wedge-shaped portion of a showerhead equal to one-quarter of an angular distance around the showerhead.

The term “radiused edge” generally represents a corner of a structure where two surfaces meet, wherein the corner is rounded instead of sharp.

The term “showerhead” generally represents a structure for distributing processing gases across a surface of a substrate. A showerhead can comprise a plenum between a faceplate and a backplate, and plurality of outlet holes formed in the faceplate.

The term “substrate” generally represents any structure on which a film can be deposited.

As mentioned above, showerheads are used in many semiconductor processing tools to distribute processing gases in a relatively even manner across a substrate. A showerhead can include a faceplate joined to a backplate to define a plenum. Processing gases are introduced into the plenum through an inlet in the backplate. The processing gases flow from the plenum through a plurality of outlet holes distributed across the faceplate toward the substrate.

The faceplate can be joined to the backplate at multiple attachment points. For example, a perimeter region of the backplate can be joined to a perimeter region of the faceplate by a welded joint. Further, a plurality of posts can join the faceplate and backplate at multiple locations within the plenum. The posts can be formed integrally with the faceplate and welded to the backplate.

During a substrate processing cycle, a substrate on a pedestal in a processing chamber can be heated to relatively high temperatures. The faceplate, which directly faces the substrate, is radiatively heated during substrate processing. The backplate can be cooled by a fluid cooling system during use. Such a fluid cooling system can attach to a stem portion of the backplate. Thus, a temperature gradient exists along the showerhead from the faceplate to the backplate during substrate processing.

The temperature gradient can cause the faceplate to thermally expand in a radial direction (across a plane of the faceplate) at a greater rate than the backplate. The greater rate of thermal expansion of the faceplate compared to the backplate can have various mechanical effects. For example, the temperature gradient can cause the backplate to be radially stretched and the faceplate to be radially compressed. This can cause the faceplate to bow away from the backplate.

The posts that connect the faceplate and the backplate function to resist this bowing effect. However, the greater rate of thermal expansion faceplate compared to the backplate can apply strain to the posts. This is because the location at which the post meets the faceplate is displaced by thermal expansion a larger magnitude radially than the location at which the post meets the backplate. Further, posts that are closer to a perimeter of the showerhead plenum can experience a greater degree of strain than posts closer to a center of the showerhead plenum, as the magnitude of thermal expansion is higher at the perimeter of the plenum than closer to the center of the plenum. Over many cycles of heating, the strain experienced by the posts can pose a risk of fracturing the posts.

Some recipes require cycling between substrate processing conditions that use very high temperature—equal to or greater than 570° C. In some instances, the showerhead could be subject to plasma cleaning processes that use pedestal temperatures up to 485° C. Subjecting showerheads to recipes that include these types of processes (e.g., recipes that cycles through very high temperature and low temperature), has been found to pose a particular risk of post fracture.

Accordingly, examples are disclosed that relate to showerheads that can avoid subjecting posts between the backplate and faceplate to excessive strain. For example, the disclosed example showerheads can utilize a thicker faceplate than conventional showerheads. In some examples, the faceplate thickness is greater than 0.35 inch and less than or equal to 1.00 inch. In comparison, conventional showerheads typically have a faceplate with a thickness of 0.35 inch or below. Heat transfer between the faceplate and the backplate of a showerhead occurs primarily at the perimeter of the showerhead, where the faceplate and backplate are welded together. The use of a thick faceplate (thickness greater than 0.35 inch) can allow more heat to be conducted per unit time from the faceplate to the backplate at the showerhead perimeter than the use of a conventional faceplate (thickness of 0.35 inch or less). This can provide for a lower temperature differential between a faceplate and a backplate in a showerhead having a thick faceplate compared to showerheads having a faceplate with a thickness of 0.35 inch or less. The lower temperature differential can reduce a thermal expansion differential between the faceplate and the backplate. This can result in less strain on the posts compared to a showerhead that experiences higher temperature differentials between the faceplate and the backplate.

Alternatively or additionally, in some examples, an outermost set of posts that join the faceplate and the backplate of the showerhead are located within a range of 45% to 65% of a distance from a center of the plenum to a perimeter of the plenum. No posts are positioned between the outermost set of posts and the perimeter of the plenum. In some such examples, the outermost set of posts is positioned within a range of 52% to 58% of a distance from a center of the plenum to a perimeter of the plenum. Again, no posts are positioned between the outermost set of posts and the perimeter of the plenum. An arrangement of posts that places no posts between a perimeter of the plenum and the higher end of these ranges can avoid subjecting the posts to repeated strain during substrate processing that can lead to fracture. Further, placing no posts between the perimeter of the plenum and 58% of the distance between the center of the plenum and the perimeter of the plenum can subject the outermost set of posts to less strain than posts placed at 65% of the distance between the center of the plenum and the perimeter of the plenum. This can further help to avoid fracture of the posts from repeated thermal cycling.

In some examples, a showerhead according to the present disclosure can have 20 or more posts. In contrast, other showerheads can have fewer posts. The use of a greater number of posts can provide more resistance against faceplate bowing compared to the use of a lesser number of posts. Also, the use of a greater number of posts can provide more paths for heat transfer from the faceplate to the backplate. This can help to reduce a temperature differential between the faceplate and the backplate.

Some conventional showerheads may include post access holes that are plugged during manufacturing. A post access hole is a hole in a backplate through which a post extending from the faceplate to the backplate can be welded to the backplate during manufacturing. Current showerheads can include a plug that is welded into the post access hole during manufacturing. The use of a welded plug in a post access hole can help to avoid a hollow cathode discharge from forming in an unplugged post access hole when a plasma is formed using the showerhead as an electrode. However, welding the plug into the post access hole also increases a manufacturing cost for the showerhead. In contrast, the disclosed examples can include a radiused top edge at an opening of a post access hole in a backplate of a showerhead. The radiused top edge can help to prevent the formation of hollow cathode discharges without the use of plugging. Omitting the post access hole plugs lowers manufacturing costs.

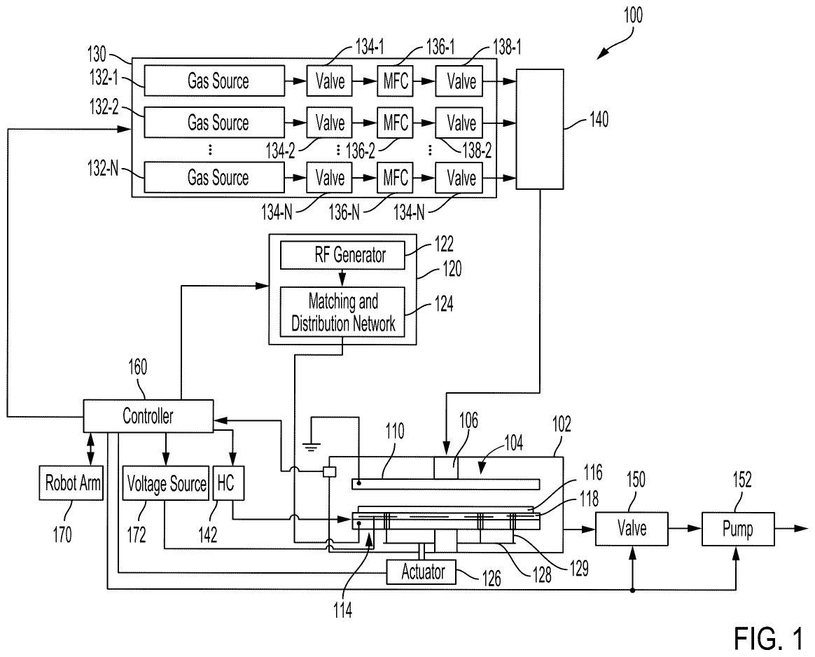

Referring now to FIG. 1, an example processing tool 100 for processing a substrate is shown. The processing tool 100 can be configured for thermal or plasma-enhanced chemical vapor deposition (CVD), thermal or plasma-enhanced atomic layer deposition (ALD), or other substrate process. The processing tool 100 comprises a processing chamber 102 containing a showerhead 104. The showerhead 104 comprises a stem 106 connected to the processing chamber. The showerhead 104 also includes a lower portion 110 that extends radially outwardly from a bottom of the stem 106. As described in more detail below, the showerhead 104 includes a faceplate comprising a plurality of outlet holes, a backplate, and a plenum between the faceplate and the backplate.

The processing tool 100 further includes a pedestal 114. The depicted pedestal 114 is configured as an electrostatic chuck pedestal. During operation, a substrate 116 is arranged on the pedestal 114. Electrodes 118 electrostatically attract the substrate 116 during processing to hold the substrate securely. In other examples, other types of pedestals can be used.

The processing tool 100 is configured to perform plasma-enhanced substrate treatments, such as plasma-enhanced atomic layer deposition (PEALD) and plasma-enhanced chemical vapor deposition (PECVD). Thus, the processing tool 100 includes an RF generating system 120 to generate and output RF power. In this example, the pedestal 114 is configured as a powered electrode, and the showerhead 104 is grounded. In other examples, the showerhead 104 can receive power from the RF generating system 120, and the pedestal 114 can be grounded. The RF generating system 120 includes an RF generator 122 that generates the RF power. The RF generating system 120 further includes a matching and distribution network 124. The substate processing tool further includes an actuator 126 and a lift pin assembly 128. The lift pin assembly includes P lift pins 128, where P is an integer greater than 2. The actuator 126 and the lift pin assembly 128 are used during loading and unloading of the substrate 116 from the chamber.

The processing tool 100 further comprises a gas delivery system 130. The gas delivery system 100 includes one or more gas sources 132-1, 132-2, . . . , and 132-N (collectively gas sources 132), where N is an integer greater than zero. The gas sources 132 supply one or more processing gases such as deposition precursors, purge gas, etch gas, etc. In some examples, vaporized precursors may also be used (not shown). The gas sources 132 are connected by valves 134-1, 134-2, . . . , and 134-N (collectively valves 134), mass flow controllers 136-1, 136-2, . . . , and 136-N (collectively mass flow controllers 136), and valves 138-1, 138-2, . . . , and 138-N (collectively valves 138) to a manifold 140. An output of the manifold 140 is fed by the gas delivery system 130 to the processing chamber 102. For example, the output of the manifold 140 is fed to the showerhead 104.

A heater controller 142 (“HC”) is connected to resistive heaters arranged in the pedestal 114. The heater controller 142 can be used to control a temperature of the pedestal 114. In addition, the pedestal 114 can include internal channels (not shown) to flow a fluid from a fluid source (not shown) to provide further control of the pedestal and substrate temperatures.

A valve 150 and pumping system 152 can be used to evacuate reactants and products from the processing chamber 102 and/or to control pressure in the processing chamber. A controller 160 can be used to control the various components of the processing tool 100 described herein. For example, the controller 160 can cause a robot arm 170 to load the substrate 116 onto the pedestal 114, and unload the substrate 116 from the pedestal 114. The controller 160 communicates with the gas delivery system 130 to control supply of process, purge and/or inert gases. The controller communicates with the valve 150 and pump 152 to control pressure within the processing chamber and/or evacuation of reactants. The controller 160 also causes a voltage source 172 to output voltage to the electrodes 118 to clamp and unclamp the substrate.

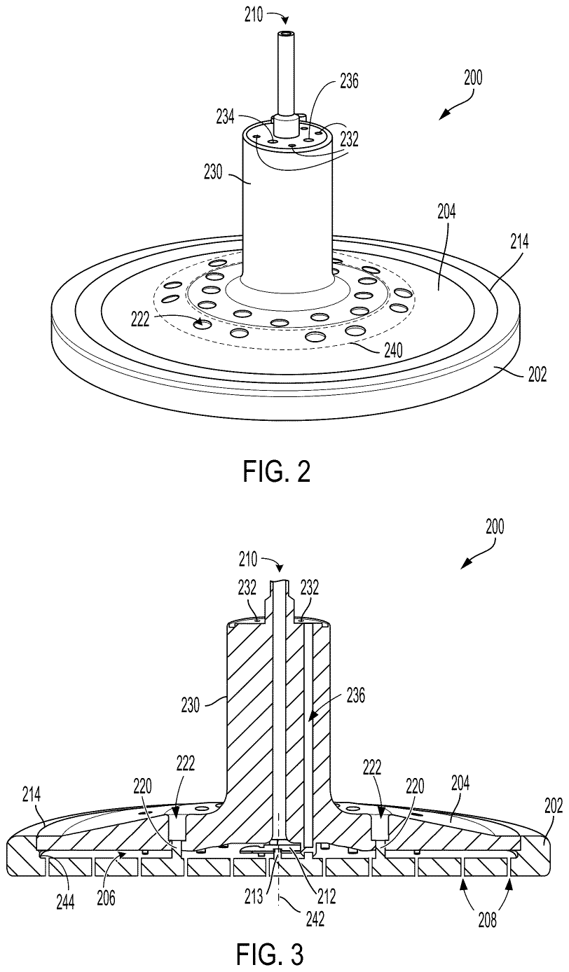

FIG. 2 shows a perspective view of an example showerhead 200. FIG. 3 shows a sectional view of the showerhead 200. The showerhead 200 is an example of the showerhead 104 of FIG. 1. The showerhead 200 comprises a faceplate 202 and a backplate 204. Referring to the sectional view of FIG. 3, a plenum 206 is located between the faceplate 202 and the backplate 204. The faceplate 202 includes a plurality of outlet holes 208 that lead from the plenum 206 to an exterior of the showerhead 200. In some examples, a showerhead may have on the order of hundreds or thousands of outlet holes. The outlet holes 208 of FIG. 2 are shown schematically and are not drawn to scale.

The plenum 206 receives processing gases through a processing gas inlet 210. A baffle 212 is located inside the plenum 206 beneath the processing gas inlet 210. The baffle 212 is mounted to the faceplate 202 within the plenum by a plurality of mounts 213. In some examples, the baffle 212 can be mounted by three mounts 213. In other examples, the baffle 212 can be mounted by any other suitable number of mounts 213. Processing gases flow into the plenum 206, impinge on the baffle 212, and distribute throughout the plenum 206. The baffle 212 helps to prevent a higher flow of processing gases from being emitted from outlet holes 208 immediately below the processing gas inlet 210 than from other outlet holes.

As mentioned above, the faceplate 202 of showerhead 200 can have a greater thickness than the faceplates of conventional showerheads. Heat transfer between the faceplate 202 and the backplate 204 of the showerhead 200 occurs primarily at the perimeter of the showerhead 200, where the faceplate 202 and the backplate 204 are welded together. In some examples, the faceplate 202 can have a thickness greater than 0.35 inch and less than or equal to 1.00 inch. The use of faceplate comprising a thickness within this range can allow more heat to be conducted per unit time from the faceplate to the backplate at the showerhead perimeter than the use of a faceplate comprising a thickness of 0.35 inch or less. This can provide for a lower temperature differential between a faceplate and a backplate compared to showerheads having a faceplate with a thickness of 0.35 inch or less. The lower temperature differential between the faceplate 202 and the backplate 204 can reduce a thermal expansion differential between the faceplate and the backplate. This can result in less strain on posts 220 (described below) that connect the faceplate 202 and the backplate 204 compared to a showerhead that experiences higher temperature differentials between the faceplate and the backplate.

In some examples, the faceplate 202 can have a thickness within a range of 0.45 inch to 0.65 inch. Depending on the operating condition, the faceplate 202 can have a thickness of 0.45, 0.50, 0.55, 0.60, 0.65 inch, as examples. Faceplates within this range of thicknesses can provide for sufficient thermal conductivity to avoid excessive strain on posts, while being easier to manufacture than faceplates that are thicker than 0.65 inch. For example, the outlet holes 208 are formed by drilling through the faceplate 202. The outlet holes 208 can have uniform narrow diameters that pose challenges when drilling through thicker materials. Further, as mentioned above, the showerhead 200 can have hundreds or thousands of outlet holes 208. Thus, drilling a large number of outlet holes 208 through a faceplate thicker than 0.65 inch can take more time and incur greater expenses than drilling the outlet holes 208 through a faceplate in the range of 0.25 and 0.65 inch. Thus, a faceplate with a thickness of between 0.45 and 0.65 inch can provide a suitable balance between manufacturability and heat transfer performance.

In some examples, the faceplate 202 and the backplate 204 can be joined at a welded joint 214 at a perimeter of the plenum 206 by friction stir welding. Friction stir welding is a non-melting joining process, and has no heat affected zone where material can be weakened in a melt-joining method. Further, the penetration depth of friction stir welding can be controlled more precisely than a melt-joining method. This is at least due to the friction stir welding penetration depth being controlled by the stir bit, rather than by delivered power. Also, friction stir welding can achieve deeper penetration than melt-joining processes while generating less faceplate deformation from residual stress than melt-joining methods. Friction stir welding can increase an operational lifetime of the perimeter joint between the faceplate and the backplate compared to melt-joining methods.

Continuing with FIG. 3, the showerhead 200 comprises a plurality of posts 220 that connect the faceplate 202 and the backplate 204. Two posts 220 are shown in sectional view in FIG. 3 The posts 220 can be formed integrally with the faceplate 202, and welded to the backplate 204. The backplate 204 includes a post access hole 222 for each post 220. Referring to FIG. 2, and as described in more detail below, the backplate 204 has a total of twenty-four post access holes 222, and the faceplate 202 has a corresponding twenty-four posts 220. The post access holes 222 allow the posts 222 to be welded to the backplate 204 during showerhead manufacturing. For example, electron beam welding can be used to weld the posts 222 by placing each posts 220 into a corresponding post access holes 222, and directing an electron beam into the post access hole 222 to fuse the post with the backplate. In some examples, the showerhead 200 may have 25 to 30 total posts. The additional posts would be placed in the radial range where the outermost set of posts are located. For certain operations it is not ideal to have too many posts because too many posts may reduce the gas flow rate. No outlet hole can be placed under the posts; therefore, more posts could equate to less outlet holes.

As mentioned above, posts in showerheads can experience cyclic strain due to temperature and thermal expansion differentials between the faceplate and the backplate. Posts that are closer to a perimeter of the showerhead plenum can experience a greater degree of strain than posts closer to a center of the showerhead plenum. This is because the magnitude of thermal expansion mismatch is higher at the perimeter of the plenum than closer to the center of the plenum.

Thus, showerhead 200 positions an outermost set of posts 240 (illustrated by a dashed line boundary around the corresponding post holes 222) between 45% and 65% of a distance from a radial center of the plenum 206 indicated by dashed line 242 (hereinafter referred to as the center 242 of the plenum 206) to a perimeter 244 of the plenum 206. The term “outermost set of posts” indicates a set of posts 220 closest to the perimeter 244 of the plenum 206. The showerhead 200 has no posts 220 positioned between 65% and 100% of the distance from the center 242 of the plenum 206 to the perimeter 244 of the plenum 206. Positioning the outermost set of posts 240 within the range of 45% to 65% of the distance from the center 242 of the plenum 206 to the perimeter 244 of the plenum 206 can provide sufficient resistance to thermal bowing of the faceplate 202 while avoiding unduly straining the posts 220. The use of a relatively thicker faceplate 202 (for example, greater than 0.35 inches and less than 1.0 inches thick) can further help to avoid excessive strain on the posts 220. This is because such a faceplate 202 can transfer more heat per unit from the faceplate 202 to the backplate 204 than a backplate 204 with a thickness of 0.35 inch or thinner. This can help reduce temperature and thermal expansion differentials between the faceplate 202 and the backplate 204 compared to the use of a thinner faceplate 202.

In some examples, the outermost set of posts 240 is positioned between 50% and 65% of the distance from the center 242 of the plenum 206 to the perimeter 244 of the plenum 206. Positioning the outermost posts at a distance of 50% of the distance from the center 242 of the plenum 206 to the perimeter 244 of the plenum 206 can provide more resistance to thermal deformation of the faceplate 202 than an outermost set of posts positioned a distance less than 50% of the distance from the center 242 of the plenum 206 to the perimeter 244 of the plenum 206. In further examples, the outermost set of posts 240 is positioned between 52 and 58% of the distance from the center 242 of the plenum 206 to the perimeter 244 of the plenum 206. In such examples, no posts are positioned between 58% and 100% of the distance from the center 242 of the plenum 206 to the perimeter 244 of the plenum 206. Posts 220 positioned within this range can provide an optimal balance between avoiding harmful strain to the posts 220 and supporting the faceplate 202 against thermal bowing in some examples.

Continuing with FIGS. 2 and 3, the backplate includes a showerhead stem 230. The showerhead stem 230 includes a plurality of attachment holes 232 for attaching the showerhead 200 within a processing tool. The showerhead stem 230 also includes one or more holes 234 for accommodating an electric heater or heaters (not shown), and one or more holes 236 for accommodating one or more corresponding temperature probe. In other examples, a showerhead stem can have any other suitable configuration.

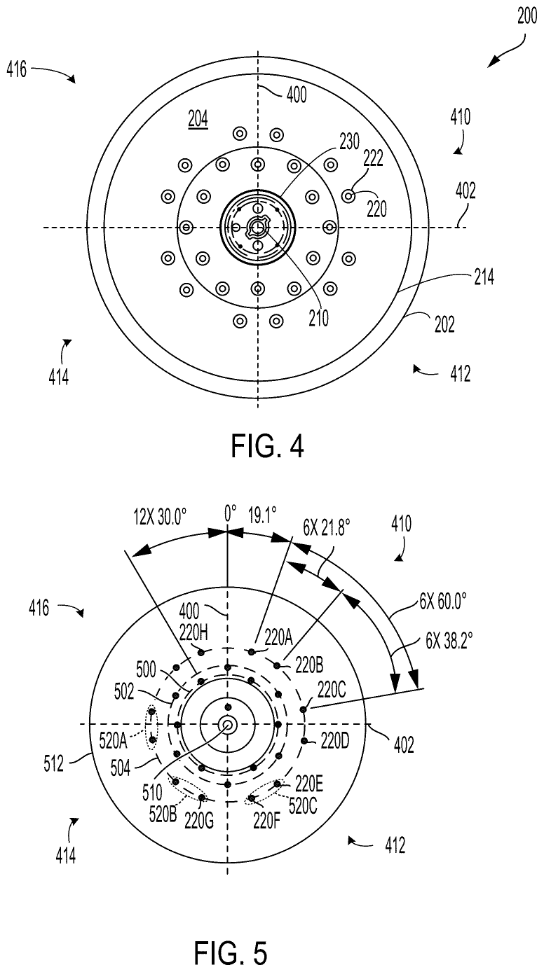

The posts 220 are positioned to avoid impeding the flow of processing gases within the plenum 206. In some examples, the posts can be positioned such that any radial line extending from the center of the plenum to the perimeter 244 of the plenum intersects a maximum of one post. FIG. 4 shows a top view of the showerhead 200, and illustrates an example placement of the post access holes 222 on the backplate 204. FIG. 5 schematically illustrates an example placement of posts 220 on the faceplate 202. As can be seen in FIG. 5, any radial line drawn from the center 242 of the plenum to a perimeter 244 of the plenum intersects a maximum of one post 220. As the gas inlet 210 is located at a center of the plenum, gases impinge the baffle 212 and then diffuse through the plenum 206. In addition to the advantages disclosed above, the depicted arrangement of posts 220 may help to ensure that gases are distributed evenly within the plenum 206 before exiting the plenum 206 through outlet holes 208.

As mentioned above, in some examples, a showerhead according to the present disclosure can have twenty or more posts. Continuing with FIGS. 4 and 5, the showerhead 200 comprises twenty four posts. An inner twelve posts are arranged in a generally hexagonal arrangement. FIG. 5 depicts the posts 220 as dark circles. FIGS. 4 and 5 each illustrate lines 400, 402 that define quadrants of the showerhead, namely, a first quadrant 410, a second quadrant 412, a third quadrant 414, and a fourth quadrant 416. Referring to FIG. 5, posts 220 are indicated by solid dark circles. It can be seen that the inner twelve posts are arranged along an inner circle 500 and a middle circle 502. The outermost set of posts, shown at 240 by a pair of dashed lines in FIG. 2, are shown in FIG. 5 arranged along an outer circle 504.

With regard to the inner twelve posts, proceeding in a clockwise direction from the vertical quadrant line, the first quadrant 410 includes posts on the middle circle 502 at 0 degrees, then on the inner circle 500 at 30 degrees, and then on the middle circle 502 at 60 degrees. The second quadrant 412 includes posts on the inner circle 500 at 90 degrees, then on the middle circle 502 at 120 degrees, and then on the inner circle 500 at 150 degrees. The third quadrant 414 includes posts on the middle circle 502 at 180 degrees, then on the inner circle 500 at 210 degrees, and then on the middle circle 502 at 240 degrees. The fourth quadrant 416 includes posts on the inner circle 500 at 270 degrees, then on the middle circle 502 at 300 degrees, and then on the inner circle 500 at 330 degrees. In other examples, any other suitable number of and arrangement of inner posts can be used.

Some conventional showerheads may include a few posts arranged in the plenum. However, the conventional showerheads do not include posts arranged in the ranges described by this disclosure. In FIG. 5, the posts of the outermost set of posts 240 are shown as dark circles arranged along the outer circle 504. The outermost set of posts along outer circle 504 also includes twelve posts. Each of the first quadrant 410, the second quadrant 412, the third quadrant 414, and the fourth quadrant 416 comprises three posts in the outermost set of posts. Further, in each quadrant, a first post of the outermost set of posts in the quadrant is spaced from a second post of the outmost set of posts in the quadrant by a first angular distance along the outer circle 504. Further, the second post of the outermost set of posts in the quadrant is separated from a third posts of the outermost set of posts in the quadrant by a second angular distance. The first angular distance is shorter than the second angular distance. For example, referring to the first quadrant 410, a first post 220A of the outermost set of posts 240 along circle 504 is spaced from a second post 220B by 21.8 degrees. The second post 220B is separated from a third post 220C by an angular distance of 38.2 degrees. Thus, the first post 220A is separated from the third post 220C by sixty degrees. This spatial pattern repeats every sixty degrees around the outer circle 504. More specifically, the relative separations between the first post 220A, the second post 220B, and the third post 220C are the same as the relative separations between the third post 220C, a fourth post 220D, and a fifth post 220E. The same relative separations are between the fifth post 220E, a sixth post 220F, and a seventh post 220G. The pattern continues to repeat in this manner around the outer circle 504.

The depicted arrangement of posts forms other patterns as well. For example, continuing with FIG. 5, the second quadrant 412 has a pattern of posts 220 along the outer circle 504 that is the mirror image across line 402 of the pattern of posts along the outer circle 504 in first quadrant 410. The third quadrant has a pattern of posts along the outer circle 504 that is the mirror image across line 400 of the pattern of posts along the outer circle 504 in the second quadrant. The fourth quadrant has a pattern of posts along the outer circle 504 that is the mirror image of the first quadrant 410 across line 400, and the mirror image of the third quadrant 414 across line 402.

In the depicted arrangement of posts, each post of the outermost set of posts (along the outer circle 504) is relatively closer to one adjacent post, and relatively farther from another adjacent post. For example, the second post 220B on the outer circle 504 is closer to the first post 220A than it is to the third post 220C. Similarly, the first post 220A is closer to the second post 220B than it is to a post 220H in an opposite direction along the outer circle 504. In this manner, the outer posts form a pattern in which pairs of posts are distributed along the outer circle 504. Example pairs of posts are illustrated as pair 520A, pair 520B and pair 520C.

FIG. 5 also illustrates that the outermost set of posts along the outer circle 504 are spaced between 52% and 58% of a distance between a center of a plenum 510, and a perimeter of the plenum 512. As described above, outermost posts located within such a radial distance range can help to resist thermally induced bowing of the faceplate while avoiding excessive strain that can lead to a fracture risk due to thermal cycling over a lifetime of the showerhead. In other examples, the outermost set of posts can be located with a range of 50% to 65% of the distance between the center of the plenum and the perimeter of the plenum. An outmost set of posts between 58% and 65% of the distance between the center of the plenum and the perimeter of the plenum can provide additional support against bowing compared to an outermost set of posts that is located at less than 58% of this distance. In further examples, the outermost set of posts can be located within a range of 45% to 65% of the distance between the center of the plenum and the perimeter of the plenum. Locating the outermost set of posts at the lower end of this range (e.g. less than 50% of the distance between the center of the plenum and the perimeter of the plenum) can subject the outermost posts to less strain from thermal expansion differentials between the faceplate and the backplate compared to locations at the higher end of this range.

FIG. 5 illustrates specific example radial and angular locations of posts 220. The depicted radial and angular locations are examples of angular locations that can help to achieve suitably uniform gas flow within the plenum 220 of the showerhead 200. However, the specific angular locations shown are presented for the purpose of example and are not intended to be limiting. In other examples, one or more posts 220 each can have a radial location and/or an angular location other than those shown. Further, in other examples, a showerhead may have either fewer or more than 24 posts. Additionally, in other examples, a quadrant may have fewer or more than three posts in an outmost set of posts.

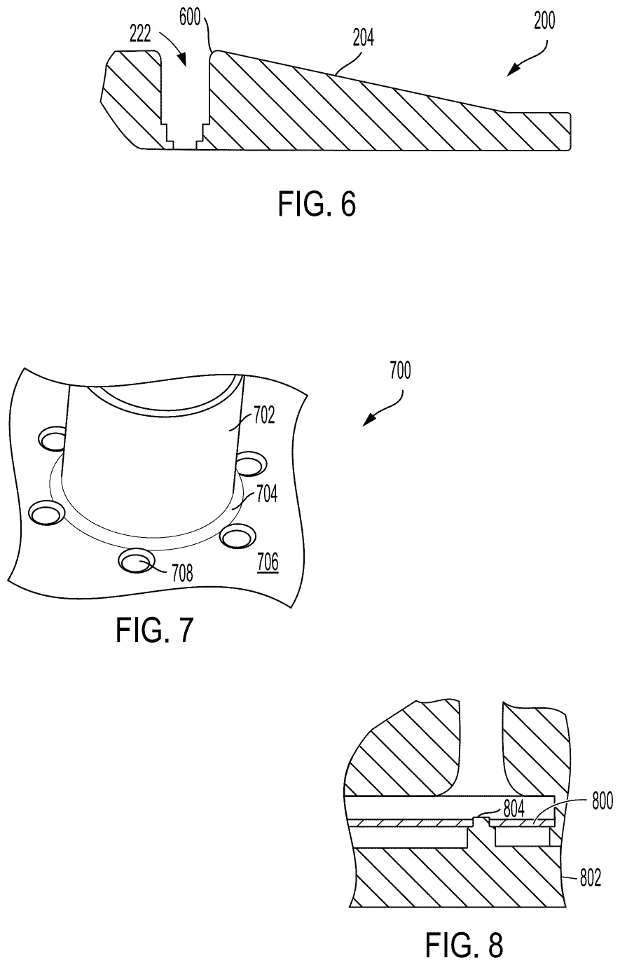

As mentioned above, post access holes in some showerheads are plugged during manufacturing after welding the posts of the showerhead faceplate to the backplate through the post access holes. Plugging a post access hole can help to avoid hollow cathode discharge forming in the post access hole during use of the showerhead as an electrode to form a plasma. The formation of such parasitic plasmas decrease a plasma power used for substrate processing. However, plugging the post access holes generally involves welding a plug into each post access hole. This increases the time and cost of manufacturing a showerhead. However, it has been found that the plugging of post access holes can be avoided by forming a radiused edge the post access hole opening on the showerhead backplate. FIG. 6 shows a sectional view of a portion of showerhead 200, and illustrates a radiused edge 600 at an opening of a post access hole 222 to an outer surface of the backplate. The radiused edge can have any suitable radius of curvature. Examples include radii of curvature within a range of 0.05 inch to −0.25 inch. The stated range is inclusive of the range endpoints.

Referring next to FIG. 7, in some such examples, each post of a showerhead can comprise a radius where the post meets an inner surface plane of a faceplate. FIG. 7 shows a portion of shows an example showerhead 700 comprising a post 702 with a radius 704 where the post meets an inner surface plane of a faceplate 706. The radius 704 can help to distribute strain experienced by the post 702 over a larger area than where a post lacks the radius 704. FIG. 7 also shows a plurality of outlet holes 708 arranged around the post 702. Post 702 and radius 704 are arranged so that an ordinary pattern of outlet holes 708 across the faceplate 706 of the showerhead is not disturbed by the post 702 and radius 704.

As mentioned above, a showerhead can include a baffle positioned in a plenum of the showerhead. Processing gases entering the showerhead through a gas inlet can impinge on the baffle and diffuse to other parts of the plenum. The use of such a baffle can help prevent greater quantities of processing gases from flowing out of outlet holes immediately below the gas inlet than out of outlet holes located closer to a perimeter of the plenum. Referring briefly back to FIGS. 3, the baffle 212 is mounted to a plurality of mounts 213. The mounts 213 can be integral with the faceplate 202, or attached to the faceplate 202.

In some examples, a baffle can be welded to mounts that support the baffle. In other examples, a baffle can be swaged to the mounts. The term “swaged” refers to the mechanical connection of two parts by pushing a mounting post on one part into an opening on the other part. The mounting post is held by compression/friction within the opening. Further, in some examples, a distal end of the post can be flared after pushing the post through the opening.

FIG. 8 shows an example of a baffle 800 attached to a baffle mount 802 by swaging. The baffle 800 is pushed onto the baffle mount 802 such that the baffle mount 802 is compressively fit into a hole in the baffle 800. Further, pressure can be applied to a distal end 804 of the baffle mount 802 to form a flared shape at the distal end 804. This can help keep the baffle 800 attached to the baffle mount 802 during repeated thermal cycling.

The disclosed example showerheads comprise structural features including, for example, unique arrangements of posts, optimized faceplate thickness, and novel post access hole configurations that can address long-felt needs in the semiconductor processing industry. For a recipe to work, the showerhead must be able to tolerate the required processing conditions. With advancements in wafer fabrication technology, more recipes are now requiring extreme operating conditions. For example, as mentioned above, certain recipes may require processing conditions that would pose a particularly high risk of post fracture. Some recipes require cycling between substrate processing conditions that use very high temperature-equal to or greater than 570° C. In some instances, the showerhead could be subject to plasma cleaning processes that use pedestal temperatures up to 485° C. When a post cracks, the showerhead is destroyed. There has been a need to develop a showerhead that can endure more extreme operating conditions for a longer period of time.

It would be expected that adding an outermost set of posts at a greater distance from a plenum center than the outermost set of posts in conventional showerheads would pose an even greater risk of fracture. However, the disclosed post placements and faceplate thicknesses unexpectedly provide a lower risk of post fracture. The disclosed post placements and faceplate thicknesses help to provide for improved heat transfer between the faceplate and backplate compared to heat transfer in a conventional showerhead. This lowers the thermal expansion differential between the faceplate and the backplate, reducing strain on the posts, especially for recipes that requires extreme operating conditions. In contrast, simply adding more posts may not help increase the lifetime of a showerhead. In fact, random or incorrect placement of posts can pose a risk of shorter showerhead lifetimes. Further, some arrangements of additional posts can harm processing gas flow uniformity in a showerhead plenum. Non-unform processing gas flow rates in the plenum can lead to nonuniform substrate processing, as different device regions on a substrate receive different processing gas flows.

The disclosed post placements and faceplate thickness represent a careful balancing of performance and manufacturability considerations that provide the unexpected advantage of a lower risk of post fracture even though the outermost set of posts is farther from a center of a plenum than in conventional showerheads. The disclosed post arrangements compared to conventional showerheads are carefully positioned to avoid impacting processing gas flow uniformity in the showerhead plenum. Further, the use of radiused corners at the openings of post access holes can avoid the formation of parasitic plasmas without the use of post access hole plugs. This helps avoid the plasma power being reduced by the parasitic plasmas.

It will be understood that the configurations and/or approaches described herein are exemplary in nature, and that these specific examples are not to be considered in a limiting sense, because numerous variations are possible. The subject matter of the present disclosure includes all novel and non-obvious combinations and sub-combinations of the various processes, systems and configurations, and other features, functions, acts, and/or properties disclosed herein, as well as any and all equivalents thereof.

The subject matter of the present disclosure includes all novel and non-obvious combinations and sub-combinations of the various processes, systems and configurations, and other features, functions, acts, and/or properties disclosed herein, as well as any and all equivalents thereof.

1. A showerhead for a substrate processing tool, the showerhead comprising:
a faceplate comprising a plurality of outlet holes;
a backplate coupled to the faceplate;
a plenum between the faceplate and backplate; and
a plurality of posts connecting the faceplate and the backplate, an outermost set of posts of the plurality of posts being positioned between 45% and 65% of a distance from a center of the plenum to a perimeter of the plenum and no posts being positioned between 65% and 100% of the distance from the center of the plenum to the perimeter of the plenum.

2. The showerhead of claim 1, wherein the outermost set of posts of the plurality of posts is positioned between 50 and 65% of the distance from the center of the plenum to the perimeter of the plenum.

3. The showerhead of claim 1, wherein the outermost set of posts of the plurality of posts is positioned between 52 and 58% of the distance from the center of the plenum to the perimeter of the plenum, and wherein no posts are positioned between 58% and 100% of the distance from the center of the plenum to the perimeter of the plenum.

4. The showerhead of claim 3, wherein the plurality of posts are arranged such that any radial line extending from the center of the plenum to the perimeter of the plenum intersects a maximum of one post.

5. The showerhead of claim 1, wherein the plurality of posts are arranged such that any radial line extending from the center of the plenum to the perimeter of the plenum intersects a maximum of one post.

6. The showerhead of claim 1, wherein the plurality of posts comprises 20 or more posts.

7. The showerhead of claim 1, wherein the faceplate has a thickness greater than 0.35 inch and equal to or less than 1 inch.

8. The showerhead of claim 7, wherein the faceplate has a thickness within a range of 0.45 inch to 0.65 inch.

9. The showerhead of claim 1, wherein the backplate comprises a post access hole for each post, each post access hole comprising a radiused edge at an opening of the post access hole to an outer surface of the backplate.

10. The showerhead of claim 1, wherein each post is integral with the faceplate and welded to the backplate, and wherein each post comprises a radius where the post meets an inner surface plane of the faceplate.

11. The showerhead of claim 1, wherein the outermost set of posts is arranged in a circular pattern with at least three posts per each quadrant of the circular pattern, a first post being spaced from a second post of the three posts by a first angular distance along the circular pattern, and the second post being spaced from a third post by a second angular distance along the circular pattern, the first angular distance being shorter than the second angular distance.

12. A showerhead for a substrate processing tool, the showerhead comprising:
a faceplate comprising a plurality of outlet holes;
a backplate coupled to the faceplate;
a plenum between the faceplate and backplate;
a plurality of posts connecting the faceplate and the backplate; and
a plurality of post access holes formed in the backplate, each post access hole comprising a radiused edge at an opening of the post access hole to an outer surface of the backplate.

13. The showerhead of claim 12, wherein a radius of curvature of the radiused edge is within a range of 0.05 inch to 0.25 inch.

14. The showerhead of claim 12, wherein an outermost set of posts of the plurality of posts is positioned between 52 and 58% of a distance from a center of the plenum to a perimeter of the plenum, and wherein no posts are positioned between 58% and 100% of the distance from the center of the plenum to the perimeter of the plenum.

15. The showerhead of claim 12, wherein the plurality of posts are arranged such that any radial line extending from the center of the plenum to a perimeter of the plenum intersects a maximum of one post.

16. The showerhead of claim 12, wherein the plurality of posts comprises 20 or more posts.

17. The showerhead of claim 12, wherein the faceplate has a thickness greater than 0.45 inch and equal to or less than 0.55 inch.

18. A showerhead for a substrate processing tool, the showerhead comprising:
a faceplate comprising a plurality of outlet holes;
a backplate coupled to the faceplate;
a plenum between the faceplate and backplate; and
a plurality of posts connecting the faceplate and the backplate, an outermost set of posts of the plurality of posts being arranged in a circular pattern with at least three posts per each quadrant of the circle pattern, a first post being spaced from a second post of the three posts by a first angular distance along the circular pattern, and the second post being spaced from a third post by a second angular distance along the circular pattern, the first angular distance being shorter than the second angular distance.

19. The showerhead of claim 18, wherein the outermost set of posts of the plurality of posts is positioned between 52 and 58% of a distance from a center of the plenum to a perimeter of the plenum, and wherein and no posts are positioned between 58% and 100% of the distance from the center of the plenum to the perimeter of the plenum.

20. The showerhead of claim 18, wherein the backplate comprises a post access hole for each post, each post access hole comprising a radiused edge at an opening of the post access hole to an outer surface of the backplate.
